(19) United States
(12) Patent Application Publication
(10) Pub. No.: US 2020/0171794 A1
(43) Pub. Date: Jun. 4, 2020

(54) METHOD FOR PRODUCING COMPOSITE ELEMENTS BY MEANS OF SPECIFIC APPLICATION OF A BONDING AGENT

(71) Applicant: Covestro Deutschland AG, Leverkusen (DE)

(72) Inventor: Klaus Franken, Bergisch Gladbach (DE)

(21) Appl. No.: 16/623,801

(22) PCT Filed: Jul. 2, 2018
(86) PCT No.: PCT/EP2018/067790

§ 371 Date: Dec. 18, 2019

(30) Foreign Application Priority Data
Jul. 7, 2017 (EP) 17180272.1

(51) Int. Cl. B32B 7/14; B32B 5/20; B32B 37/00; B32B 38/00; B05C 5/02; C08G 18/76; C08G 18/48

(52) U.S. Cl. CPC B32B 7/14; B32B 5/20; B32B 37/0076; B32B 38/145; B32B 2266/0278; B05C 5/0225; C08G 18/7671; C08G 18/485; B32B 2305/022; B05C 5/0291

(57) ABSTRACT

The invention relates to a method for producing composite elements, comprising the steps: 1) providing a first cover layer; 2) applying a first reaction mixture, which reacts to a bonding agent, to the cover layer; 3) applying a second reaction mixture, which reacts to a polyurethane/polyisocyanurate foam, to the first cover layer so that the first reaction mixture, applied to the first cover layer, is contacted at least in part by the second reaction mixture. According to the invention, the bonding agent is preferably a 2K bonding agent, the components of which are applied separately and according to a predetermined pattern and react to the bonding agent on the substrate.

The present invention relates to a process for producing composite elements comprising the steps of: 1) providing an outerlayer; 2) applying an adhesion promoter component to the outerlayer, wherein the adhesion promoter component comprises a one-component adhesion promoter and/or a first reaction mixture which reacts to afford an adhesion promoter, and 3) applying a second reaction mixture which reacts to afford a polyurethane/polyisocyanurate foam to the outerlayer, so that the adhesion promoter component applied to the outerlayer is at least partially contacted by the second reaction mixture.

Composite elements made of an outerlayer and an insulating core are currently employed in many industry sectors. The basic construction of such composite elements consists of an outerlayer onto which an insulating material is applied. Employable outerlayers include for example sheets of coated steel, stainless steel, aluminum, copper or alloys of the two latter metals. Insulation panels made of a combination of outerlayers and an insulating core may also be produced. Plastics films, aluminum films, wood, glass fiber or mineral fiber nonwovens and also cellulose-containing materials such as paper, cardboard or papier-mâché may be used as outerlayer materials. Multilayer outerlayers made of aluminum and paper for example are often used. The choice of suitable outerlayer material depends on the intended field of application of the composite elements or insulation panel and the resulting material requirements. Employable insulating cores include in particular foams based on polyurethane (PUR) and/or polyisocyanurate (PIR). The polyurethane/polyisocyanurate foams for the above-described applications are in particular rigid PUR foams and rigid PUR/PIR foams. In the present application the term polyurethane/polyisocyanurate foam/foams is to be understood as meaning individually or collectively foams based on polyurethane (PUR) and/or polyisocyanurate (PIR) and in particular rigid foams.

Insulation panels are often employed in the construction of houses or apartments. In addition to the use of composite elements for insulation of chilled warehouses for example they are also ever more frequently employed as façade elements of buildings or as elements of industrial doors such as for example sectional doors. Such composite elements, also referred to hereinbelow as sandwich composite elements, exhibit through their outerlayer a stability and surface appearance corresponding to the material employed while the applied foam confers corresponding thermal insulation properties. To produce corresponding insulation panels or composite elements a foaming reaction mixture is applied to a provided outerlayer by means of an application apparatus. When using foams based on isocyanates for example the corresponding polyol components and isocyanate components are mixed with one another and applied onto the outerlayer upon which they undergo foaming and curing.

The processing of PIR foams in particular is typically carried out with addition of adhesion promoters, wherein two-component (2K) polyurethane adhesion promoter systems in particular have become established. Adhesive bond strengths are in principle markedly improved by the use of such 2K adhesion promoter systems. For the manufacturers of the finished parts this results in a product improvement such that the long-term risks for adhesion failure are massively reduced.

In this connection EP 1 516 720 A1 for example discloses the use of a polyurethane adhesion promoter for improving the adhesion between the layers of a composite element containing a polyisocyanurate foam and outerlayers as well as the composite elements as such and a process for their production. The employed adhesion promoter is a polyurethane-based adhesion promoter known from the prior art having a density of 400 to 1200 g/l. This adhesion promoter is generally obtainable by reaction of polyisocyanates with compounds having two isocyanate-reactive hydrogen atoms, wherein the reaction ratio is chosen such that in the reaction mixture the ratio of the number of isocyanate groups to the number of isocyanate-reactive groups is 0.8 to 1.8:1, preferably 1 to 1.6:1. Preferred embodiments relate to the use of reactive 2K polyurethane adhesion promoter that is still reactive upon combining of the foam layer and the outer layer.

The applying of the adhesion promoter to the outerlayer is often carried out using a rotating plate which distributes droplets of the 2K reaction mixture produced shortly beforehand on the outerlayer. Such a process is described inter alia in DE 10 2004 022677 A1. This document discloses an apparatus for producing sandwich composite elements consisting at least of two feeding apparatuses for outerlayers to which are serially connected an application apparatus for an adhesion promoter, an application apparatus for a core layer, a conveying apparatus and a cutting-to-length apparatus, wherein the application apparatus for the adhesion promoter consists at least of a feed conduit for the adhesion promoter, a turntable having at least one lateral outlet opening and a drive means for the turntable.

EP 1 736 324 A2 relates to a process for producing any desired pattern from a metallic or metallized layer on the surface of a substrate made of paper, plastic, metal, glass, wood or the like, wherein initially a digital dataset describing the pattern is created, then using the digital dataset and a digital printing process an activatable adhesion promoter is digitally printed onto the surface of the substrate regionally and in register with the pattern to be produced so that overlap of the printing dots is achieved and the adhesion promoter has been applied to the substrate as a smooth, even layer, then the metallic or metallized layer is extensively applied to the surface of the substrate with contact, then the adhesion promoter is activated to achieve adhesive bonding of the metallic or metallized layer with the surface of the substrate in the region of the pattern to be produced and then the metallic or metallized layer is extensively removed, the bonded regions remaining on the substrate.

WO 2008/031517 A1 discloses an apparatus for applying a substance to sheetlike substrates, in particular to textiles, carpets, films, comprising at least one application station which applies the substance to the substrate in the transverse direction and the longitudinal direction, wherein the application station is provided with a substrate-receiving means and a carrying means, which at least substantially extends over the substrate width and comprises at least one substance spraying head which is formed by a stationary arrangement of spraying nozzles distributed over the entire application width, and wherein the spraying head carrying means and the substrate are movable relative to one another in the direction of longitudinal application. The spraying head carrying means having the spraying nozzles distributed over the application width and a substrate-receiving area of the substrate receiving means are height adjustably arranged relative to one another by means of at least one lifting means such that the substance spraying head passes into at least one application operating position and into at least one position which reveals the stationary nozzles longitudinally the carrying means for maintenance.

EP 2 002 898 A1 discloses an application means for applying fluid to a substrate comprising a linear arrangement of valve means each provided with an application valve nozzle for jetting the fluid under pressure and with an accompanying valve operating means for controlling the fluid jetting by closing and opening the application valve nozzles and comprising a fluid-pressurizable common distribution fluid chamber which connects the application valve means for pressurizing with the fluid with one another, wherein the distribution fluid chamber is provided with a fluid inlet channel arranged such that the fluid pressurized in the distribution fluid chamber is distributed to the application valve means along the row thereof, characterized in that at least the one fluid inlet channel of the distribution fluid chamber is assigned at least one cleaning valve means which for connection with the distribution fluid chamber is incorporated in the linear arrangement of the application valve means and is provided with a cleaning valve nozzle and with an accompanying valve operating means for closing/opening the cleaning valve nozzle, wherein in the distribution fluid chamber between the fluid inlet channel and the at least one assigned cleaning valve means an effective flow sector for cleaning the common distribution fluid chamber is formed when the cleaning valve nozzle is open.

Application of the adhesion promoter by means of a turntable to the outerlayer in the production of foam composite elements has several disadvantages. Precise control of the application image in terms of layer thickness, patterns or uniformity is difficult or impossible. A time-independent application quality is also difficult to achieve due to encrustations of reacted adhesion promoter on the turntable. Application of the adhesion promoter is not resource-efficient since as a result of so-called “overspray” material is distributed beyond the outerlayer. The throw path of the material applied by the turntable can result in unwetted regions (shadows) in the case of profiled outerlayers. There is further always an age distribution of the applied adhesion promoter due to the geometry of the turntable. Establishment of a constant “age” or reaction stage of the adhesion promoter over the width of the outerlayer is not possible. Finally, the lengthy flight path of the adhesion promoter in the case of the turntable can cause aerosols to easily form and the plant may suffer from severe contamination (spraying). The distribution quality on the outerlayer also depends on the belt speed of the outerlayer. A turntable can be adapted thereto only to a limited extent.

The present invention has for its object to at least partially overcome at least one disadvantage of the prior art. It especially has for its object to specify a process for producing composite elements in which the application of the adhesion promoter can be made more efficient.

The object is achieved in accordance with the invention by a process as claimed in claim 1 and a system as claimed in claim 15. Advantageous developments are specified in the subsidiary claims. They may be combined as desired, unless the opposite is unambiguously apparent from the context.

A process for producing composite elements comprises the steps of:
1) providing a first outerlayer;
2) applying an adhesion promoter component to the first outerlayer, wherein the adhesion promoter component comprises a one-component adhesion promoter and/or a first reaction mixture which reacts to afford an adhesion promoter
   and wherein the first reaction mixture is obtained from a plurality of components, wherein at least one isocyanate component and at least one isocyanate-reactive component are used therefor;
3) applying a second reaction mixture which reacts to a polyurethane/polyisocyanurate foam to the first outerlayer, so that the adhesion promoter component applied to the first outerlayer is at least partially contacted by the second reaction mixture.

The adhesion promoter component is applied to the first outerlayer in a predetermined pattern.

In the case where in step 2) a one-component adhesion promoter is applied, the one-component adhesion promoter is ejected from a nozzle in the form of individual droplets under instruction from a control unit until the predetermined pattern has been applied.

In the case where in step 2) a first reaction mixture is applied, the applying of the first reaction mixture to the first outerlayer in step 2) comprises the steps of:
2a) applying a droplet of a first component selected from the components employed for the first reaction mixture according to the predetermined pattern to the first outerlayer;
2b) applying a droplet of a further component selected from the components employed for the first reaction mixture according to the predetermined pattern to a previously applied droplet of another component of the first reaction mixture, so that a previously applied droplet of another component is at least partially contacted;
2c) repeating the steps 2a) and 2b) until the predetermined pattern has been applied using all components of the first reaction mixture;
   wherein in step 2a) and/or step 2b) the applying of the droplets is carried out such that under instruction from a control unit an individual droplet is ejected from a nozzle.

Suitable as the first outerlayer are for example metal sheets or foils, in particular aluminum sheets or foils, multilayer outerlayers, made of aluminum and paper for example, and plastic films. The width of the first outerlayer is unlimited in principle. For example the first outerlayer may have a width between 1000 and 1300 mm, but a width of 2400 mm is also possible.

The second reaction mixture reactive to afford a polyurethane/polyisocyanurate foam comprises an isocyanate-reactive component, for example a polyol, a polyisocyanate, optionally additives such as for example stabilizers and catalysts, optionally one or more flame retardants and one (or more) blowing agents.

The polyol comprises in particular a base polyol component selected from the group consisting of polyether polyols, polyester polyols, polyether ester polyols, polycarbonate polyols and/or polyether-polycarbonate polyols and mixtures of these polyols. The OH number of the employed polyol or of the employed polyols may be for example >100 mg KOH/g to <800 mg KOH/g and the average OH functionality of the employed polyol or of the employed polyols is ≥2. In the case of a single added polyol the OH number indicates the OH number of said polyol. In the case of mixtures the average OH number is reported. This value may be determined in accordance with DIN 53240. The average OH functionality of the polyols is for example in a range from ≥2 to <6.

The base polyol component, when employed for PIR foams, preferably has functionalities of ≥1.2 to ≤3.5, in particular ≥1.6 to ≤2.4, and has a hydroxyl number between 100 and 300 mg KOH/g, preferably 150 to 270 mg KOH/g and especially preferably 160-260 mg KOH/g. The base polyol component preferably has more than 70 mol %, preferably more than 80 mol %, in particular more than 90 mol %, of primary OH groups. The proportion of base polyol component is preferably at least 50% by weight and particularly preferably at least 65% by weight based on the total weight of the isocyanate-reactive component and additives.

In the context of the present invention the number-average molar mass Mn (also known as molecular weight) is determined by gel permeation chromatography according to DIN 55672-1 of August 2007.

The “hydroxyl number” indicates the amount of potassium hydroxide in milligrams which is equivalent in an acetylation to the acetic acid quantity bound by one gram of substance. In the context of the present invention said number is determined according to the standard DIN 53240-2 (1998).

In the context of the present invention the “acid number” is determined according to the standard DIN EN ISO 2114:2002-06.

In the context of the present invention “functionality” describes the theoretical average functionality (number of isocyanate-reactive or polyol-reactive functions in the molecule) calculated from the known input materials and their quantity ratios.

In the context of this application “a polyether polyol” may also be a mixture of different polyether polyols, wherein in this case the mixture of the polyether polyols in its entirety has the recited OH number. This applies analogously to the further herein-recited polyols and their indices.

Also employable in the isocyanate-reactive component in addition to the above-described polyols of the base polyol component are further isocyanate-reactive compounds:

The addition of long-chain polyols, in particular polyether polyols, can bring about an improvement in the flowability of the reaction mixture and the emulsifiability of the blowing agent-containing formulation. For the production of composite elements with the process according to the invention these can allow continuous production of elements with flexible or rigid outerlayers.

These long-chain polyols have functionalities of ≥1.2 to ≤3.5 and have a hydroxyl number between 10 and 100 mg KOH/g, preferably between 20 and 50 mg KOH/g. They comprise more than 70 mol %, preferably more than 80 mol %, in particular more than 90 mol %, of primary OH groups. The long-chain polyols are preferably polyether polyols having functionalities of ≥1.2 to ≤3.5 and a hydroxyl number between 10 and 100 mg KOH/g.

The addition of medium-chain polyols, in particular polyether polyols, and low molecular weight isocyanate-reactive compounds can bring about an improvement in the adhesion and dimensional stability of the resulting foam. For the production of composite elements with the process according to the invention these medium-chain polyols can allow continuous production of elements with flexible or rigid outerlayers. The medium-chain polyols, which are in particular polyether polyols, have functionalities of ≥2 to ≤6 and have a hydroxyl number between 300 and 700 mg KOH/g.

The polyethers employed in accordance with the invention as the base polyol or as the long-chain or medium-chain usable polyether polyols additionally present in the isocyanate-reactive component are the polyether polyols having the recited features which are employable in polyurethane synthesis and are known to those skilled in the art.

Employable polyether polyols are for example polytetramethylene glycol polyethers such as are obtainable by polymerization of tetrahydrofuran by cationic ring opening.

Likewise suitable polyether polyols are addition products of styrene oxide, ethylene oxide, propylene oxide, butylene oxide and/or epichlorohydrin onto di- or polyfunctional starter molecules. The addition of ethylene oxide and propylene oxide is especially preferred. Suitable starter molecules are for example water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, bisphenols, in particular 4,4′-methylenebisphenol, 4,4′-(1-methylethylidene)bisphenol, 1,4-butanediol, 1,6-hexanediol and low molecular weight hydroxyl-containing esters of such polyols with dicarboxylic acids and oligoethers of such polyols.

Suitable polyester polyols are inter alia polycondensates of di- and also tri- and tetraols and di- and also tri- and tetracarboxylic acids or hydroxycarboxylic acids or lactones. Instead of the free polycarboxylic acids, it is also possible to use the corresponding polycarboxylic anhydrides or corresponding polycarboxylic esters of lower alcohols to prepare the polyesters.

Examples of suitable diols are ethylene glycol, butylene glycol, diethylene glycol, triethylene glycol, polyalkylene glycols such as polyethylene glycols and also 1,2-propanediol, 1,3-propanediol, 1,3-butanediol, 1,4-butanediol, 1,6-hexanediol and isomers, neopentyl glycol or neopentyl glycol hydroxypivalate. Also employable in addition are polyols such as trimethylolpropane, glycerol, erythritol, pentaerythritol, trimethylolbenzene or trishydroxyethyl isocyanurate.

Additional co-use of monohydric alkanols is also possible.

Examples of polycarboxylic acids that may be used include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, or trimellitic acid. It is also possible to use the corresponding anhydrides as acid source.

Additional co-use of monocarboxylic acids such as benzoic acid and alkanecarboxylic acids is also possible.

Hydroxycarboxylic acids that may be co-used as reaction participants in the production of a polyester polyol having terminal hydroxyl groups are for example hydroxycaproic acid, hydroxybutyric acid, hydroxydecanoic acid, hydroxystearic acid and the like. Suitable lactones include caprolactone, butyrolactone and homologs.

Suitable compounds for producing the polyester polyols also include in particular bio-based starting materials and/or derivatives thereof, for example castor oil, polyhydroxy fatty acids, ricinoleic acid, hydroxyl-modified oils, grapeseed oil, black cumin oil, pumpkin kernel oil, borage seed oil, soybean oil, wheat germ oil, rapeseed oil, sunflower kernel oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified fatty acids and epoxidized fatty acids and fatty acid esters, for example based on myristoleic acid, palmitoleic acid, oleic acid, vaccenic acid, petroselic acid, gadoleic acid, erucic acid, nervonic acid, linoleic acid, alpha- and gamma-linolenic acid, stearidonic acid, arachidonic acid, timnodonic acid, clupanodonic acid and cervonic acid. Especially preferred are esters of ricinoleic acid with polyfunctional alcohols, for example glycerol. Also preferred is the use of mixtures of such bio-based acids with other carboxylic acids, for example phthalic acids.

The polyester polyols of the base polyol component preferably have an acid number of 0-5 mg KOH/g. This ensures that blocking of aminic catalysts by conversion into ammonium salts takes place only to a limited extent and the reaction kinetics of the foaming reaction are impaired only to a small extent.

Polycarbonate polyols that may be used are hydroxyl-containing polycarbonates, for example polycarbonate diols. These are formed in the reaction of carbonic acid derivatives, such as diphenyl carbonate, dimethyl carbonate or phosgene, with polyols, preferably diols.

Examples of such diols are ethylene glycol, propane-1,2- and -1,3-diol, butane-1,3- and -1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenols and lactone-modified diols of the abovementioned type.

Also employable instead of or in addition to pure polycarbonate diols are polyether-polycarbonate diols obtainable for example by copolymerization of alkylene oxides, such as for example propylene oxide, with CO2.

Employable polyether ester polyols are compounds containing ether groups, ester groups and OH groups. Organic dicarboxylic acids having up to 12 carbon atoms are suitable for producing the polyether ester polyols, preferably aliphatic dicarboxylic acids having ≥4 to ≤6 carbon atoms or aromatic dicarboxylic acids used individually or in admixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. Also employable in addition to organic dicarboxylic acids are derivatives of these acids, for example their anhydrides and also their esters and monoesters with low molecular weight monofunctional alcohols having ≥1 to ≤4 carbon atoms. The use of proportions of the abovementioned bio-based starting materials, in particular of fatty acids/fatty acid derivatives (oleic acid, soybean oil etc.), is likewise possible and can have advantages, for example in respect of storage stability of the polyol formulation, dimensional stability, fire behavior and compressive strength of the foams.

Polyether polyols obtained by alkoxylation of starter molecules such as polyhydric alcohols are a further component used for producing polyether ester polyols. The starter molecules are at least difunctional, but may optionally also contain proportions of higher-functional, in particular trifunctional, starter molecules.

Starter molecules include for example diols having number-average molecular weights Mn of preferably ≥18 g/mol to ≤400 g/mol, preferably of ≥62 g/mol to ≤200 g/mol, such as 1,2-ethanediol, 1,3-propanediol, 1,2-propanediol, 1,4-butanediol, 1,5-pentenediol, 1,5-pentanediol, neopentyl glycol, 1,6-hexanediol, 1,7-heptanediol, 1,8-octanediol, 1,10-decanediol, 2-methyl-1,3-propanediol, 2,2-dimethyl-1,3-propanediol, 3-methyl-1,5-pentanediol, 2-butyl-2-ethyl-1,3-propanediol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomeric mixtures of alkylene glycols, such as diethylene glycol. Starter molecules having functionalities distinct from OH may also be employed alone or in admixture.

In addition to the diols compounds having >2 Zerewitinoff-active hydrogens, in particular having number-average functionalities of >2 to ≤8, in particular of ≥3 to ≤6, may also be co-used as starter molecules for producing the polyethers, for example 1,1,1-trimethylolpropane, triethanolamine, glycerol, sorbitan and pentaerythritol and also triol- or tetraol-started polyethylene oxide polyols having average molar masses Mn of preferably ≥62 g/mol to ≤400 g/mol, in particular of ≥92 g/mol to ≤200 g/mol.

Polyether ester polyols may also be produced by alkoxylation, in particular by ethoxylation and/or propoxylation, of reaction products obtained by the reaction of organic dicarboxylic acids and their derivatives and components with Zerewitinoff-active hydrogens, in particular diols and polyols. Derivatives of these acids that may be used include, for example, their anhydrides, for example phthalic anhydride.

Production processes of the polyols have been described for example by Ionescu in “Chemistry and Technology of Polyols for Polyurethanes”, Rapra Technology Limited, Shawbury 2005, p. 55 et seq. (chapt. 4: Oligo-Polyols for Elastic Polyurethanes), p. 263 et seq. (chapt. 8: Polyester Polyols for Elastic Polyurethanes) and in particular to p. 321 et seq. (chapt. 13: Polyether Polyols for Rigid Polyurethane Foams) and p. 419 et seq. (chapt. 16: Polyester Polyols for Rigid Polyurethane Foams). It is also possible to obtain polyester and polyether polyols by glycolysis of suitable polymer recyclates. Suitable polyether-polycarbonate polyols and the production thereof are described for example in EP 2910585 A, [0024]-[0041]. Examples relating to polycarbonate polyols and production thereof may be found inter alia in EP 1359177 A. Production of suitable polyether ester polyols is described inter alia in WO 2010/043624 A and in EP 1 923 417 A.

The isocyanate-reactive component may further contain low molecular weight isocyanate-reactive compounds, in particular di- or trifunctional amines and alcohols, particularly preferably diols and/or triols having molar masses Mn of less than 400 g/mol, preferably of 60 to 300 g/mol, for example triethanolamine, diethylene glycol, ethylene glycol, glycerol. Polyol compounds falling under the definition of medium-chain polyol compounds are excluded from the group of low molecular weight isocyanate-reactive compounds. Provided such low molecular weight isocyanate-reactive compounds are used for producing the polyurethane/polyisocyanurate foams, for example as chain extenders and/or crosslinking agents, these are advantageously employed in an amount of up to 5% by weight based on the total weight of the isocyanate-reactive component.

In addition to the above-described polyols and isocyanate-reactive compounds the isocyanate-reactive component may contain further isocyanate-reactive compounds, in particular polyamines, polyamino alcohols and polythiols. It will be appreciated that the described isocyanate-reactive components also comprise compounds having mixed functionalities.

In a further preferred embodiment the isocyanate-reactive component contains at least one polyester polyol having a functionality of functionalities of ≥1.2 to ≤3.5 and a hydroxyl number of number from 100 to 300 mg KOH/g and also an acid number of 0 to 5.0 mg KOH/g in an amount of 65-100% by weight based on the total weight of the isocyanate-reactive component; and a polyether polyol having a functionality of ≥1.8 to ≤3.5 and a hydroxyl number of 10 to 100 mg KOH/g, preferably 20 to 50 mg KOH/g, in an amount of 0% to 15% by weight based on the total weight of the isocyanate-reactive component and the additives in the second reaction mixture.

The reaction mixture may contain additives, for example assistant and additive substances, and catalysts. These may be added to the isocyanate-reactive component in whole or in part or metered into the mixture of the components directly. The assistant and additive substances comprise all components typically added to isocyanate-reactive compositions. Examples include emulsifiers, cell regulators, thixotropic agents, plasticizers and dyes.

The assistant and additive substances preferably comprise emulsifiers. Compounds employable as suitable emulsifiers which also act as foam stabilizers include for example all commercially available silicone oligomers modified by polyether side chains which are also employed for producing conventional polyurethane foams. When emulsifiers are employed they are employed in amounts of preferably up to 8% by weight, particularly preferably 0.5% to 7% by weight, in each case based on the total weight of the isocyanate-reactive composition. Preferred emulsifiers are polyether polysiloxane copolymers. These are commercially available for example under the names B84504 and B8443 from Evonik, Niax L-5111 from Momentive Performance Materials, AK8830 from Maystar and Struksilon 8031 from Schill and Seilacher. Silicone-free stabilizers, such as for example LK 443 from Air Products, may also be employed.

Flame retardants may also be added to the isocyanate-reactive compositions as additives to improve flame retardancy. Such flame retardants are known in principle to the person skilled in the art and are described, for example, in “Kunststoffhandbuch”, volume 7 “Polyurethane”, chapter 6.1. These may include for example halogenated polyesters and polyols, brominated and chlorinated paraffins or phosphorus compounds, such as for example the esters of orthophosphoric acid and of metaphosphoric acid, which may likewise contain halogen. It is preferable to choose flame retardants that are liquid at room temperature. Examples include triethyl phosphate, diethylethane phosphonate, cresyldiphenyl phosphate, dimethylpropane phosphonate and tris(β-chloroisopropyl) phosphate. Flame retardants selected from the group consisting of tris(chloro-2-propyl) phosphate (TCPP) and triethyl phosphate (TEP) and mixtures thereof are particularly preferred. It is preferable to employ flame retardants in an amount of 1% to 30% by weight, particularly preferably 5% to 30% by weight, based on the total weight of the isocyanate-reactive component. It may also be advantageous to combine different flame retardants with one another to achieve particular profiles of properties (viscosity, brittleness, flammability, halogen content etc.).

The reactivity of the second reaction mixture is generally adapted to the requirements by means of the abovementioned catalysts (this definition comprises all reactivity-enhancing components including for example aminopolyethers). Catalysts are compounds suitable for catalyzing the blowing reaction, the urethane reaction and/or the isocyanurate reaction (trimerization). The catalyst components may be metered into the reaction mixture or else initially charged in the isocyanate-reactive component in whole or in part and may be adapted to the desired application in terms of type and amount. Production of thin panels thus requires a reaction mixture having a higher reactivity than production of thicker panels.

Suitable therefor are in particular one or more catalytically active compounds selected from the following groups:

D1) aminic catalysts, for example amidines, such as 2,3-dimethyl-3,4,5,6-tetrahydropyrimidine, tertiary amines, such as triethylamine, tributylamine, dimethylcyclohexylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine-1,6, pentamethyldiethylenetriamine, bis(2-dimethylaminoethyl) ether, bis(dimethylaminopropyl)urea, dimethylpiperazine, 1,2-dimethylimidazole, N,N′,N″-tris(dimethylaminopropyl)hexahydrotriazine, bis[2-(N,N-dimethylamino)ethyl] ether, 1-azabicyclo-(3,3,0)-octane and 1,4-diazabicyclo-(2,2,2)-octane, and alkanolamine compounds, such as triethanolamine, triisopropanolamine, N-methyl- and N-ethyldiethanolamine, N,N-dimethylaminoethoxyethanol, N,N,N′-trimethylaminoethylethanolamine and dimethylethanolamine. Particularly suitable compounds are selected from the group comprising tertiary amines, such as triethylamine, tributylamine, dimethylcyclohexylamine, dimethylbenzylamine, N,N,N′,N′-tetramethylethylenediamine, pentamethyldiethylenetriamine, bis(2-dimethylaminoethyl) ether, dimethylpiperazine, 1,2-dimethylimidazole and alkanolamine compounds, such as tris(dimethylaminomethyl)phenol, triethanolamine, triisopropanolamine, N-methyl- and N-ethyldiethanolamine, N,N-dimethylaminoethoxyethanol, N,N,N′-trimethylaminoethylethanolamine and dimethylethanolamine.

In a particularly preferred embodiment the catalyst component employs one or more aminic compounds having the following structure:

(CH₃)₂N—CH₂—CH₂—X—CH₂—CH₂—Y

wherein Y=NR₂ or OH, preferably Y=N(CH₃)₂ or OH, particularly preferably Y=N(CH₃)₂
and wherein X=NR or O, preferably X=N—CH₃ or O, particularly preferably X=N—CH₃. Every R is choosable independently of every other R and represents an organic radical of any desired structure having at least one C atom. R is preferably an alkyl group having 1 to 12 carbon atoms, in particular C1- to C6-alkyl, particularly preferably methyl and ethyl, in particular methyl.

D2) carboxylates of alkali metals or alkaline earth metals, in particular sodium acetate, sodium octoate, potassium acetate, potassium octoate, and tin carboxylates, for example tin(II) acetate, tin(II) octoate, tin(II) ethylhexoate, tin(II) laurate, dbutyltin diacetate, dibutyltin dilaurate, dibutyltin maleate and dioctyltin acetate, and ammonium carboxylates. Sodium, potassium and ammonium carboxylates are especially preferred. Preferred carboxylates are formates, ethylhexanoates (=octoates), propionates and acetates.

The catalyst preferably contains one or more catalysts selected from the group consisting of potassium acetate, potassium octoate, pentamethyldiethylenetriamine, N,N′,N″-tris(dimethylaminopropyl)hexahydrotriazine, tris(dimethylaminomethyl)phenol, bis[2-(N,N-dimethylamino)ethyl] ether, dimethylbenzylamine and N,N-dimethylcyclohexylamine, particularly preferably from pentamethyldiethylenetriamine, N,N′,N″-tris(dimethylaminopropyl)hexahydrotriazine and N,N-dimethylcyclohexylamine, particularly preferably from pentamethyldiethylenetriamine, N,N′,N″-tris(dimethylaminopropyl)hexahydrotriazine and N,N-dimethylcyclohexylamine in combination with potassium acetate, potassium octoate or potassium formate or sodium formate.

It is preferable to use a combination of catalyst components D1 and D2 in the reaction mixture. In this case the molar ratio should be chosen such that the D2/D1 ratio is between 0.1 and 80, in particular between 2 and 20. Short fiber times may be achieved for example with more than 0.9% by weight of potassium 2-ethylhexanoate based on all components of the reaction mixture.

The polyisocyanate is an isocyanate having an NCO functionality of ≥2. Examples of such suitable polyisocyanates include 1,4-butylene diisocyanate, 1,5-pentane diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs, 1,3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) having C1- to C6-alkyl groups.

Preferably employed as the polyisocyanate are mixtures of the isomers of diphenylmethane diisocyanate (“monomeric MDI”, “mMDI” for short) and oligomers thereof (“oligomeric MDI”). Mixtures of monomeric MDI and oligomeric MDI are generally described as “polymeric MDI” (pMDI). The oligomers of MDI are higher-nuclear polyphenylpolymethylene polyisocyanates, i.e. mixtures of the higher-nuclear homologs of diphenylmethylene diisocyanate which have an NCO functionality f>2 and may be described by the following empirical formula: C₁₅H₁₀N₂O₂[C₈H₅NO]ₙ, wherein n=integer >0, preferably n=1, 2, 3 and 4. Higher-nuclear homologs C₁₅H₁₀N₂O₂[C₈H₅NO]ₘ, m=integer ≥4) may likewise be present in the mixture of organic polyisocyanates. Likewise preferred as the polyisocyanate component are mixtures of mMDI and/or pMDI comprising at most up to 20% by weight, more preferably at most 10% by weight, of further aliphatic, cycloaliphatic and especially aromatic polyisocyanates known for the production of polyurethanes, very particularly TDI.

The polyisocyanate moreover has the feature that it preferably has a functionality of at least 2, in particular at least 2.2, particularly preferably at least 2.4 and very particularly preferably at least 2.7.

The NCO content in the polyisocyanate is preferably from ≥29.0% by weight to ≤33.0% by weight and preferably has a viscosity at 25° C. of ≥80 mPas to ≤2900 mPas, particularly preferably of ≥95 mPas to ≤850 mPas at 25° C.

The NCO value (also known as NCO content, isocyanate content) is determined according to EN ISO 11909:2007. Unless otherwise stated values at 25° C. are concerned.

In addition to the abovementioned polyisocyanates, it is also possible to co-use proportions of modified diisocyanates of uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

Also employable as the organic polyisocyanate instead of or in addition to the abovementioned polyisocyanates are suitable NCO prepolymers. The prepolymers are producible by reaction of one or more polyisocyanates with one or more polyols corresponding to the above-described polyols. The isocyanate may be a prepolymer obtainable by reaction of an isocyanate having an NCO functionality of ≥2 and polyols having a molar mass Mn of ≥62 g/mol to ≤8000 g/mol and OH functionalities of ≥1.5 to ≤6.

Isocyanate-reactive component and polyisocyanate are mixed to produce a reaction mixture which can react to afford polyurethane/polyisocyanurate foams. This reaction mixture may be produced directly in a mixing head.

The isocyanate index (also known as the index) is to be understood as meaning the quotient of the actually employed amount of substance [mol] of isocyanate groups and the actually employed amount of substance [mol] of isocyanate-reactive groups, multiplied by 100:

Index=(mols of isocyanate groups/mols of isocyanate-reactive groups)*100.

In the reaction mixture the number of NCO groups in the isocyanate and the number of isocyanate-reactive groups may result in an index of 90 to 600, preferably between 115 and 400. The index is preferably in a range from >180 to <450 (in this range a high proportion of polyisocyanurates (PIR) is present and the (rigid) foam is described as PIR foam or PUR/PIR foam). Another preferred range for the isocyanate index is the range from >90 to <140 (in this range the (rigid) foam is described as a polyurethane foam (PUR foam)).

The second reaction mixture further contains sufficient blowing agent as is required for achieving a dimensionally stable foam matrix and the desired apparent density. This is generally 0.5-30 parts by weight of blowing agent based on 100 parts by weight of the component A. Preferably employed blowing agents are physical blowing agents selected from at least one member of the group consisting of hydrocarbons, halogenated ethers and perfluorinated and partially fluorinated hydrocarbons having 1 to 8 carbon atoms. In the context of the present invention “physical blowing agents” are to be understood as meaning compounds which on account of their physical properties are volatile and unreactive toward the isocyanate component. The physical blowing agents to be used according to the invention are preferably selected from hydrocarbons (for example n-pentane, isopentane, cyclopentane, butane, isobutane, propane), ethers (for example methylal), halogenated ethers, (per)fluorinated hydrocarbons having 1 to 8 carbon atoms (for example perfluorohexane) and mixtures thereof with one another. Also preferred is the use of (hydro)fluorinated olefins, for example HFO 1233zd(E) (trans-1-chloro-3,3,3-trifluoro-1-propene) or HFO 1336mzz(Z) (cis-1,1,1,4,4,4-hexafluoro-2-butene) or additives such as FA 188 from 3M (1,1,1,2,3,4,5,5,5-nonafluoro-4-(trifluoromethyl)pent-2-ene) and the use of combinations of these blowing agents. In particularly preferred embodiments the blowing agent employed is a pentane isomer or a mixture of different pentane isomers. It is exceptionally preferable to employ a mixture of cyclopentane and isopentane as the blowing agent. Further examples of preferably employed hydrofluorocarbons are for example HFC 245fa (1,1,1,3,3-pentafluoropropane), HFC 365mfc (1,1,1,3,3-pentafluorobutane), HFC 134a or mixtures thereof. Different blowing agent classes may also be combined.

Also especially preferred is the use of (hydro)fluorinated olefins, for example HFO 1233zd(E) (trans-1-chloro-3,3,3-trifluoro-1-propene) or HFO 1336mzz(Z) (cis-1,1,1,4,4,4-hexafluoro-2-butene) or additives such as FA 188 from 3M (1,1,1,2,3,4,5,5,5-nonafluoro-4(or 2)-(trifluoromethyl)pent-2-ene and/or 1,1,1,3,4,4,5,5,5-nonafluoro-4(or 2)-(trifluoromethyl)pent-2-ene), alone or in combination with other blowing agents. These have the advantage of having a particularly low ozone depletion potential (ODP) and a particularly low global warming potential (GWP).

Chemical blowing agents (also referred to as “co-blowing agents”) may be employed instead of or in addition to the abovementioned physical blowing agents. These are particularly preferably water and/or formic acid. The chemical blowing agents are preferably employed together with physical blowing agents. It is preferable when the co-blowing agents are employed in an amount up to 6% by weight, particularly preferably 0.5% to 4% by weight, for the composite elements based on the total amount of compounds having isocyanate-reactive hydrogen atoms in the second reaction mixture.

Preferably employed for composite elements is a mixture of 0 and 6.0% by weight of co-blowing agent and 1.0% to 30.0% by weight of blowing agent in each case based on 100% by weight of the total amount of isocyanate-reactive component and the additives. However, the quantity ratio of co-blowing agent to blowing agent may also be from 1:7 to 1:35 according to requirements.

The adhesion promoter component employed in the process according to the invention may be a one-component adhesion promoter (1K) or a multi-component adhesion promoter. The adhesion promoter component may comprise two, three, four or more individual components, for example, which react together to afford the adhesion promoter. In terms of suitable polyisocyanates, polyols etc. the compounds recited previously in connection with the second reaction mixture are in principle likewise suitable, wherein the formulation of the adhesion promoter is preferably optimized to improve the adhesion properties of the PUR/PIR foam on the outerlayer.

According to the invention it is further provided that the adhesion promoter component is applied to the first outerlayer in a predetermined pattern. The process according to the invention thus differs not only from the application of the 2K adhesion promoter reaction mixture to the first outerlayer by means of a turntable but also from the spray-application of the 2K mixture or of the individual components onto the first outerlayer which all bring about a random distribution and not a controlled distribution of the adhesion promoter on the first outerlayer.

When the adhesion promoter component or individual components thereof are ejected from a nozzle they have a viscosity (ISO 3219:1993; German version of EN ISO 3219:1994 at 20° C.) of for example ≤2 Pas, preferably ≤1 Pas and more preferably ≤200 mPas.

The predetermined pattern is preferably already present in the control unit as a rastered pattern on account of the realization of the pattern via droplets of for example a first and second component of the first reaction mixture. However, it is also possible to use a raster image processor (RIP) to produce the rastered pattern from any desired sources in the control unit. In the terminology of printing the rastered pattern may be considered a multicolor image for example—the primary colors are the components of the first reaction mixture—wherein the “color” represents the stoichiometric ratio of the two components and may be the same everywhere or may also deliberately differ. In the latter case, the RIP may also undertake a color separation and as a result separate the predetermined pattern into two or more subpatterns.

In the process according to the invention a distinction is made between a 1K adhesion promoter or a multi-component adhesion promoter. In the case of the 1K adhesion promoter said promoter is applied dropwise under instruction from a control unit. Contemplated here are hot melt adhesives as well as moisture-curable, thermally curable or UV-curable 1K polyurethane systems

In the case of multi-component adhesion promoters the applying of the first reaction mixture (that which reacts to afford the adhesion promoter) in step 2) comprises a plurality of substeps. In step 2a) a droplet of a first component is applied to the first outerlayer. This first component is selected from the components which together form the first reaction mixture. The applying is carried out according to the predetermined pattern.

In step 2b) a droplet of a further component selected from the components which together form the first reaction mixture is applied. It is goes without saying that this component is distinct from the first component.

This contacting of the droplets takes place in step 2b). The droplet of the later component preferably contacts the previously applied droplet of the first component completely, so that the most efficient possible mixing of the components may be effected. The most efficient possible mixing may also be controlled via the choice of droplet sizes for the components which, however, should vary from one another as little as possible in the context of the chosen reaction stoichiometry.

Step 2c) finally provides for repeating the steps 2a) and 2b) until the predetermined pattern of the droplets has been applied. In the individual steps 2a) of the process the applied droplets may be applied to the first outerlayer isolated from one another or sufficiently close together to form a continuous structure. The same applies to the droplets applied in step 2b). It is possible to apply to the substrate initially all droplets of the first component and subsequently all droplets of the further components. It is also possible to perform the steps 2a) and 2b) alternately. Hybrid forms of these two approaches are likewise conceivable.

It will be appreciated that step 2b) is carried out for each component of the first reaction mixture that is distinct from the first component.

The applying of the droplets in step 2a) and/or 2b), wherein the alternative which provides for steps 2a) and 2b) is preferred, is carried out under instruction from the control unit such that an individual droplet is ejected from one nozzle. The application of the droplets is accordingly discretized, the process according to the invention thus likewise differing from a non-discretized spray application. Step 2) of the process is accordingly conceptionally comparable to an ink jet printing process and, having regard to the terminology of additive manufacturing/3D printing, may be described as 2D printing. The frequency with which the nozzle ejects individual droplets may be in the range from ≥10 Hz to ≤10000 Hz, preferably ≥500 Hz to ≤1500 Hz liegen.

In step 2a) and/or step 2b) the droplets may for example have a volume of ≥0.1 nL to ≤1000 nL. In step 2a) and step 2b) the droplets preferably have a volume of ≥10 nL to ≤500 nL, more preferably ≥15 nL to ≤440 nL.

Furthermore, in step 2a) and/or 2b) the droplets may be applied for example with a resolution of ≥5 dpi (dots per inch) to ≤100 dpi. In step 2a) and 2b) the droplets are preferably applied with a resolution of ≥10 dpi to ≤100 dpi, more preferably ≥20 dpi to ≤80 dpi, particularly preferably ≥30 dpi to ≤60 dpi.

The nozzle or nozzles from which the droplets are ejected may be sealed off from atmospheric humidity by an inert gas.

In one embodiment of the process according to the invention the first reaction mixture is obtained from an isocyanate component and an isocyanate-reactive component and the applying of the first reaction mixture to the first outerlayer in step 2) comprising the steps of:
2a) applying a droplet of a first component selected from isocyanate component and isocyanate-reactive component according to the predetermined pattern to the first outerlayer;
2b) applying a droplet of a second component which constitutes the other component selected from isocyanate component and isocyanate-reactive component according to the predetermined pattern to a previously applied droplet of the first component, so that the previously applied droplet of the first component is at least partially contacted by the droplet of the second component;
2c) repeating the steps 2a) and 2b) until the predetermined pattern of the droplets has been applied;
   wherein in step 2a) and/or step 2b) the applying of the droplet is carried out such that under instruction from a control unit an individual droplet is ejected from a nozzle.

The first reaction mixture is here obtained from an isocyanate component and an isocyanate-reactive component. Accordingly a 2-component (2K) system is concerned. In terms of suitable polyisocyanates, polyols etc. the compounds recited previously in connection with the second reaction mixture are in principle likewise suitable, wherein the formulation of the adhesion promoter is preferably optimized to improve the adhesion properties of the PUR/PIR foam on the outerlayer.

In step 2a) a droplet of a first component is applied to the first outerlayer. This first component is either the isocyanate component or the isocyanate-reactive component. In step 2b) a droplet of a second component which constitutes the component complementary to the first component is applied. If the first component is the isocyanate component the second component is the isocyanate-reactive component. In the opposite case when the first component is the isocyanate-reactive component the second component is the isocyanate component.

In step 2a) the droplet of the first component is applied to the first outerlayer according to the predetermined pattern. To obtain the first reaction mixture which reacts to afford an adhesion promoter this droplet, i.e. the material of the first component present on the outerlayer which was applied to the outerlayer in the form of the droplet, is contacted with the second component.

This contacting is carried out in step 2b). The droplet of the second component preferably contacts the previously applied droplet of the first component completely, so that the most efficient possible mixing of the components may be effected. The most efficient possible mixing may also be controlled via the choice of droplet sizes for the first and second component which, however, should vary from one another as little as possible in the context of the chosen reaction stoichiometry.

Step 2c) finally provides for repeating the steps 2a) and 2b) until the predetermined pattern of the droplets has been applied. In the individual steps 2a) of the process the applied droplets may be applied to the outerlayer isolated from one another or sufficiently close together to form a continuous structure. The same applies to the droplets applied in step 2b). It is possible to apply to the substrate initially all droplets of the first component and subsequently all droplets of the second component. It is also possible to perform the steps 2a) and 2b) alternately. Hybrid forms of these two approaches are likewise conceivable.

The applying of the droplet in step 2a) and/or 2b), wherein the alternative which provides for steps 2a) and 2b) is preferred, is carried out under instruction from the control unit such that an individual droplet is ejected from one nozzle.

In a further embodiment of the process according to the invention the adhesion promoter component is applied to the first outerlayer with an area density of ≥10 g/m² to 200 g/m² (preferably ≥50 g/m² to 100 g/m²).

In a further embodiment of the process according to the invention the adhesion promoter component is applied to the first outerlayer with a coverage of ≥10% to ≤90% (preferably ≥20% to ≤70%). The coverage is to be understood as meaning the proportion of the surface of the first outerlayer covered by the adhesion promoter component.

In a further embodiment of the process according to the invention the volume ratio and/or the frequency of the droplets applied in step 2a) and 2b) change over time. Different volume ratios of the components of the 2K adhesion promoter make it possible to control the molar ratio of NCO groups to Zerewitinoff-active H atoms (index) in the first reaction mixture. The index can then also be changed over the course of the process according to the invention by changing the volume ratios with time. This makes it possible to account for spatially distinct requirements for the nature of the adhesion promoter if for example a slightly more rigid adhesion promoter at the edge of the outerlayer and a slightly more flexible adhesion promoter in the middle of the outerlayer are desired.

In a further embodiment of the process according to the invention the first reaction mixture comprises an isocyanate component, a first isocyanate-reactive component and a second isocyanate-reactive component and the first isocyanate-reactive component and the second isocyanate-reactive component each have a different reaction rate with the isocyanate component when considered in isolation. Different reaction rates are achievable for example through polyols of different reactivities or through a different catalyst or catalyst proportion. This then also makes it possible to achieve temporal and spatial control of the reaction profile (rate of the reaction affording the adhesion promoter). This may find use for example when the belt speed is to be altered and the adhesion promoter is nevertheless to arrive at the site of foam introduction with the optimal reaction conversion.

In a further embodiment of the process according to the invention the predetermined pattern in which the first reaction mixture is applied to the outerlayer is selected from lines, waves, points or a combination thereof. The pattern may also exhibit local or temporal variation.

In a further embodiment of the process according to the invention in step 2a) and/or 2b) a plurality of nozzles is arranged in a printing head. This printing head may then be placed for example on a robot arm or movably on a crossbar over the outerlayer.

In a further embodiment of the process according to the invention the printing head extends over the entire width of the application region. It is thus fixedly installed and need no longer be moved.

In a further embodiment of the process according to the invention in step 2a) and/or 2b) the nozzle from which the droplet is ejected is in the form of a needle valve controllable by a control unit. Suitable electromechanical or piezoelectric actuators allow the needle valve to be pulled back and thus allow the droplet to exit the nozzle. The advantage of such a nozzle construction is its easy cleaning. The nozzle may be pressurized by the component to be ejected, for example with a pressure of 1 bar up to 300 bar.

In a further embodiment of the process according to the invention the first outerlayer moves at least during step 2). The process according to the invention is preferably a continuous process. It is suitable for the production of foam composite elements such as metal composite elements in a high-speed production procedure. Depending on thickness the outerlayer speed is for example up to 20 meters per minute, preferably up to 15 meters per minute, more preferably up to 10 meters per minute.

In a further embodiment of the process according to the invention the first outerlayer is set into vibration at least during step 2). This may be effected for example by rollers or supports attached below the outerlayer. Vibration of the outerlayer makes it possible to achieve a faster and more efficient mixing of the two components of the 2K adhesion promoter.

In a further embodiment of the process according to the invention the first outerlayer exhibits an electrostatic potential difference relative to the droplets of the first or second component. This likewise makes it possible to influence the mixing behavior of the two components of the 2K adhesion promoter.

In a further embodiment of the process according to the invention, in the first reaction mixture the first component has a higher viscosity than the second component. The viscosity of the isocyanate component and that of the isocyanate-reactive component are preferably determined at 20° C. according to DIN EN ISO 11909/ISO 3219. Applying the more viscous component before the less viscous component has advantages for the formation of the reaction mixture. Upon contacting of the droplets the underlying, more viscous component is not so easily displaced by the component impacting on it.

In a further embodiment of the process according to the invention the isocyanate-reactive component in the first reaction mixture further comprises a blowing agent. Both physical and chemical blowing agents are suitable. Gas bubble formation by the blowing agent promotes mixing of the two reaction components on the substrate.

In a further embodiment of the process according to the invention, in the first reaction mixture the isocyanate component comprises monomeric and/or polymeric 4,4′-MDI and the isocyanate-reactive component is a propylene glycol-propylene oxide polyether polyol and/or a tolylenediamine-started ethylene oxide-propylene oxide polyether polyol.

An example of a formulation for the first reaction mixture is an isocyanate component composed of polymeric MDI having a low viscosity, Desmodur 44V10 L (Covestro AG). The following formulation is employable as an isocyanate-reactive component:

59.6% by weight of propylene glycol-propylene oxide-polyether, molar mass 1000 g/mol

40.0% by weight of o-tolylenediamine-ethylene oxide-propylene oxide polyether, molar mass 540 g/mol

0.2% by weight of 1-methylimidazole

0.2% by weight of Tegostab B 8443, Goldschmidt.

In a further embodiment of the process according to the invention step 3) is followed by step 4):
4) contacting the second reaction mixture which reacts to afford a polyurethane/polyisocyanurate foam with a second outerlayer.

It is preferable when in step 4) the second outerlayer is contacted on the side facing the second reaction mixture with an adhesion promoter and/or a reaction mixture which reacts to afford an adhesion promoter as described hereinabove. Suitable as the second outerlayer are for example metal sheets or foils, in particular aluminum sheets or foils, multilayer outerlayers, made of aluminum and paper for example, and plastic films. There is generally no limitation on the width of the outerlayer. For example the outerlayer may have a width between 1000 and 1300 mm, but a width of 2400 mm is also possible. The process according to the invention may then overall be regarded as a double belt process.

The present invention further provides a system for producing composite elements comprising a transport apparatus for a first outerlayer, a first application apparatus for applying an adhesion promoter and/or a first reaction mixture which reacts to afford an adhesion promoter to the outerlayer and a second application apparatus for applying a second reaction mixture which reacts to afford a polyurethane/polyisocyanurate foam to the outerlayer. The system further comprises a control unit adapted for running a process according to the present invention. The first application apparatus is preferably arranged in order under instruction from the control unit according to a predetermined pattern:

to apply to the first outerlayer from a nozzle a single droplet of a first component selected from isocyanate component and isocyanate-reactive component corresponding to the predetermined pattern and
to apply a single droplet of a second component which constitutes the other component selected from isocyanate component and isocyanate-reactive component according to the predetermined pattern from a nozzle to a previously applied droplet of the first component, so that the previously applied droplet of the first component is at least partially contacted by the droplet of the second component.

To avoid repetition reference is made to what is stated hereinabove in connection with the process according to the invention in respect of details concerning the application of the droplets. The first application apparatus may for example be a printing head arranged on a robot arm. A further option is that the printing head is arranged on a crossbar over the outerlayer and transverse to the direction of motion of the outerlayer. A linear motion of the printing head in conjunction with the motion of the outerlayer thus makes it possible to produce in simple fashion wave patterns for the 2K adhesion promoter on the outerlayer. The printing had may also extend over the entire width of the application region. It is thus fixedly installed and need no longer be moved.

It will be appreciated that the system may also be configured as a continuously operating double belt plant. It is left open whether the second outerlayer is likewise provided with an adhesion promoter. A general scheme of a double belt plant is shown in FIG. 1 of EP 1593438 B1.

1. A process for producing composite elements, comprising:
1) providing a first outerlayer;
2) applying an adhesion promoter to the first outerlayer, wherein the adhesion promoter comprises a one-component adhesion promoter and/or a first reaction mixture which reacts to afford the adhesion promoter
and wherein the first reaction mixture is obtained from a plurality of components comprising at least one isocyanate component and at least one isocyanate-reactive component;
3) applying a second reaction mixture which reacts to form a polyurethane/polyisocyanurate foam, wherein the second reaction mixture at least partially contacts the adhesion promoter;
wherein the adhesion promoter is applied to the first outerlayer in a predetermined pattern,
wherein in the case where in step 2) the adhesion promoter comprises the one-component adhesion promoter
the one-component adhesion promoter is applied by ejecting the one-component adhesion promoter from a nozzle in the form of individual droplets under instruction from a control unit until the predetermined pattern is applied; and
wherein in the case where in step 2) the adhesion promoter comprises the first reaction mixture, the first reaction mixture is applied by a process comprising:
2a) applying a droplet of a first component selected from the components employed for the first reaction mixture according to the predetermined pattern to the first outerlayer;
2b) applying a droplet of a further component selected from the components employed for the first reaction mixture according to the predetermined pattern to a previously applied droplet of another component of the first reaction mixture, so that the previously applied droplet of another component is at least partially contacted; and
2c) repeating the steps 2a) and 2b) until the predetermined pattern is applied using all components of the first reaction mixture;
wherein in step 2a) and/or step 2b) the application of the droplets is carried out under instruction from a control unit such that individual droplets are ejected from a nozzle.

2. The process as claimed in claim 1, wherein the first reaction mixture is obtained from an isocyanate component and an isocyanate-reactive component and
the applying of the first reaction mixture to the first outerlayer in step 2) comprises:
2a) applying a droplet of the first component selected from the isocyanate component and the isocyanate-reactive component according to the predetermined pattern to the first outerlayer;
2b) applying a droplet of a second component which constitutes the other component selected from the isocyanate component and the isocyanate-reactive component according to the predetermined pattern to a previously applied droplet of the first component, so that the previously applied droplet of the first component is at least partially contacted by the droplet of the second component; and
2c) repeating the steps 2a) and 2b) until the predetermined pattern of the droplets is applied;
wherein in step 2a) and/or step 2b) the applying of the droplet is carried out such that under instruction from the control unit such that an individual droplet is ejected from a nozzle.

3. The process as claimed in claim 1, wherein the adhesion promoter is applied to the first outerlayer with an area density of ≥10 g/m² to 200 g/m².

4. The process as claimed in claim 1, wherein the adhesion promoter is applied to the first outerlayer with a coverage of ≥10% to ≤90%.

5. The process as claimed in claim 1, wherein the volume ratio and/or the frequency of the droplets applied in steps 2a) and 2b) change over time.

6. The process as claimed in claim 1, wherein the first reaction mixture comprises an isocyanate component, a first isocyanate-reactive component and a second isocyanate-reactive component and wherein the first isocyanate-reactive component and the second isocyanate-reactive component each have a different reaction rate with the isocyanate component when considered in isolation.

7. The process as claimed in claim 1, wherein the predetermined pattern in which the first reaction mixture is applied to the first outerlayer comprises lines, waves, points, or a combination thereof.

8. The process as claimed in claim 1, wherein in step 2a) and/or 2b) the applying comprises ejecting the droplets from a plurality of nozzles arranged in a printing head.

9. The process as claimed in claim 1, wherein in step 2a) and/or 2b) the applying comprises ejecting the droplets from a nozzle that is in the form of a needle valve controllable by the control unit.

10. The process as claimed in claim 1, wherein the first outerlayer moves at least during the step 2).

11. The process as claimed in claim 1, wherein in the first reaction mixture the first component has a higher viscosity than the second component.

12. The process as claimed in claim 1, wherein in the first reaction mixture the isocyanate component comprises monomeric and/or polymeric 4,4′-MDI and the isocyanate-reactive component comprises a propylene glycol-propylene oxide polyether polyol and/or a tolylenediamine-started ethylene oxide-propylene oxide polyether polyol.

13. The process as claimed in claim 1, wherein step 3) is followed by step 4), wherein step 4) comprises
contacting the second reaction mixture which reacts to afford a polyurethane/polyisocyanurate foam with a second outerlayer.

14. The process as claimed in claim 13, wherein in step 4) the second outerlayer has a side facing the second reaction mixture that contacts a second adhesion promoter and/or another reaction mixture which reacts to afford the second adhesion promoter.

15. A system for producing composite elements comprising a transport apparatus for a first outerlayer, a first application apparatus for applying an adhesion promoter and/or a first reaction mixture which reacts to afford an adhesion promoter to the outerlayer and a second application apparatus for applying a second reaction mixture which reacts to afford a polyurethane/polyisocyanurate foam to the outerlayer,
wherein the system further comprises a control unit adapted for running a process as claimed in claim 1.
